(19) United States
(12) Patent Application Publication
(10) Pub. No.: US 2011/0007937 A1
(43) Pub. Date: Jan. 13, 2011

(54) METHOD AND SYSTEM FOR MEASURING AN OBJECT OF INTEREST

(75) Inventors: Ming Yan, Shanghai (CN); Hua Jin, Shanghai (CN); Xin Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/933,886

(22) PCT Filed: Mar. 26, 2009
(86) PCT No.: PCT/IB09/51255

§ 371 Date: Sep. 22, 2010

(30) Foreign Application Priority Data
Mar. 27, 2008 (CN) 200810090345.5

(51) Int. Cl. G06K 9/00

(52) U.S. Cl. 382/100

(57) ABSTRACT

This invention relates to a system and method for measuring an object of interest (101). According to the invention, the system comprises a frame (120) having a plurality of holes (121) arranged in known positions and extending in known directions, each of the holes being arranged to cooperate with a rod (130) comprising a sensor (132); and the system comprises means (140) for measuring the position of each of the sensors (132) when the rod is inserted in the hole (121) and the sensor (132) is in contact with the surface of the object of interest (101). Furthermore, the system comprises a processor (150) for deriving the shape of the object of interest, based on the positions of the plurality of sensors.

### FIELD OF THE INVENTION

The invention relates to a method and a system for measuring an object of interest, for example in an imaging system, such as an electrical impedance tomography system or a magnetic induction tomography system.

### BACKGROUND OF THE INVENTION

Electrical impedance tomography (EIT), also referred to as applied potential tomography (APT), is an imaging technique that is particularly used in medical applications. This technique images the spatial distribution of electrical impedance inside an object, such as the human body. The technique is attractive as a medical monitoring tool, because it is non-invasive and does not use ionizing radiation, as in X-ray tomography, or the generation of strong, highly uniform magnetic fields, as in Magnetic Resonance Imaging (MRI), and can thus be used in bed-side long term in vivo monitoring.

Prior art document WO2007/128952A1 discloses an apparatus for electrical impedance imaging of an object of interest that comprises first and second electrode arrangements spaced apart to define an imaging region therebetween. An object to be imaged is locatable, during operation, in the imaging region so that impedance data can be collected from the object, using the first and second electrode arrangements, to permit the construction of an impedance image of the object.

However, as EIT electrodes are attached to the patient body, applying EIT for long-term in vivo monitoring, changes of the patient body position may affect the position of the electrodes, which may introduce errors in measurement data and thus introduce artefacts into the images reconstructed from the measurement data. Furthermore, measurement electrodes are also difficult to position accurately, because of the irregular geometry of the patient body. Therefore, it is difficult to get precise electrode-position information with the current configuration. Electrode position errors are the main contributors to the errors in the reconstruction procedure.

Obtaining accurate position information of measurement sensors, and thus of the position of the object of interest to be imaged, is also helpful for imaging reconstructions in other imaging systems. For example, when applying magnetic induction tomography (MIT) in patient monitoring, the position and shape information of the object of interest can be used for determining the imaging reconstruction region, leading to improved image quality.

### SUMMARY OF THE INVENTION

An object of the invention is to develop a system for measuring an object of interest that can help derive the position and/or the shape of the object of interest.

To this end, this invention provides a system for measuring an object of interest, comprising:

a frame having a plurality of holes arranged in known positions and extending in known directions, each of the holes being arranged to cooperate with a rod comprising a sensor; and

means for measuring the position of each of the sensors when the rod is inserted in the hole and the sensor is in contact with the surface of the object of interest.

By using the frame having holes arranged in known positions and extending in known directions, and thanks to its cooperation with the rod, the positions of the sensors, which can be used for measuring signals for imaging, can be fixed and measured, which is helpful for imaging reconstruction.

In an embodiment, the system further comprises a processor for deriving the shape of the object of interest, based on the positions of the plurality of sensors. When using the system according to the invention in an imaging system, for example a MIT system for patient monitoring, the position and shape information of the object of interest can be used for determining the imaging reconstruction region, leading to improved image quality.

Another object of the invention is to develop a method of measuring an object of interest that can help derive the position and/or the shape of the object of interest.

To this end, this invention provides a method of measuring an object of interest, comprising the steps of:

positioning a frame around the object of interest, the frame having a plurality of holes arranged in known positions and extending in known directions, each of the holes being arranged to cooperate with a rod comprising a sensor; and

measuring the position of each of the sensors when the rod is inserted in the hole and the sensor is attached to the surface of the object of interest.

In an embodiment, the measuring step comprises the sub-steps of:

calculating the distance between the sensor and the entry of the hole by reading a magnetic signal on a magnetic reader, which is fixed at the entry of the hole and arranged to cooperate with a magnetic railing ruler attached to the rod; and

calculating the positions of the sensors based on the distances and the known positions and directions of the holes.

This method has similar advantages as that mentioned for the system according to the invention.

In a further embodiment, the method further comprises a step of deriving the shape of the object of interest, based on the positions of the plurality of sensors.

Detailed explanations and other aspects of the invention will be given below.

### DESCRIPTION OF THE DRAWINGS

The above and other objects and features of the present invention will become more apparent from the following detailed description considered in connection with the accompanying drawings, in which:

FIG. 1 is a schematic diagram showing an exemplary embodiment of the system in accordance with the invention;

FIG. 2 is a schematic diagram showing another exemplary embodiment of the frame in accordance with the invention;

FIG. 3 is a schematic diagram showing another exemplary embodiment of the frame in accordance with the invention; and

FIG. 4 is a flowchart of the method in accordance with the invention.

### DETAILED DESCRIPTION

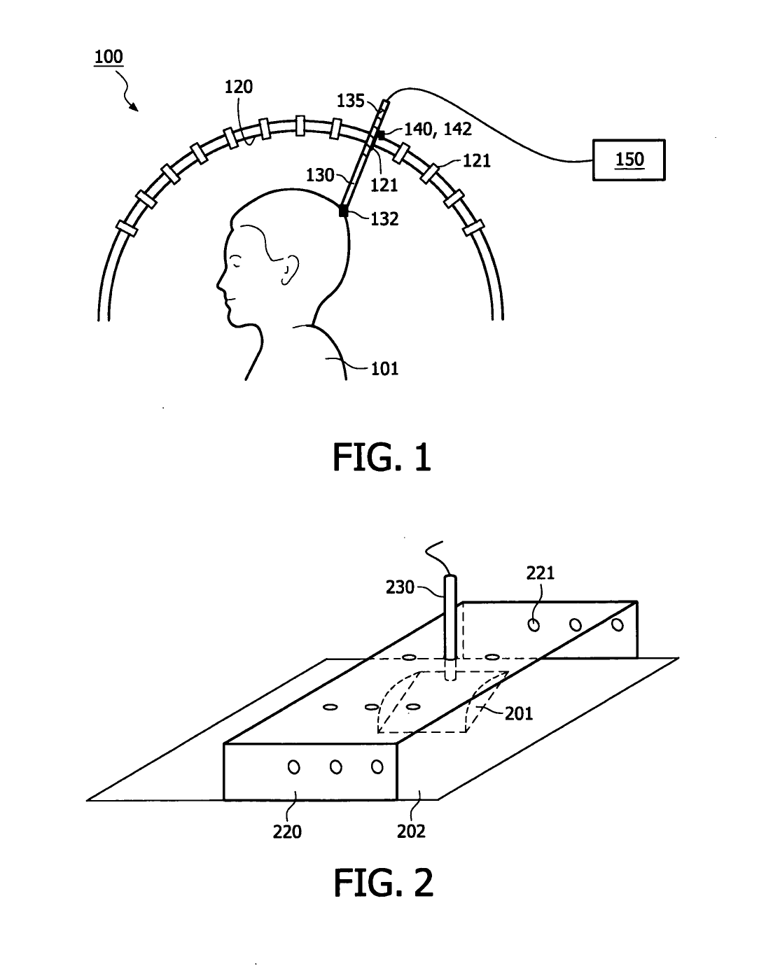

FIG. 1 is a schematic diagram showing an exemplary embodiment of the system 100 in accordance with the invention.

In the embodiment shown in FIG. 1, the system 100 comprises a frame 120 having a plurality of open holes 121 arranged in known positions and extending in known directions, each of the holes 121 being arranged to cooperate with a rod 130 comprising a sensor 132 at one end of the rod.

In an embodiment, the frame 120 is in the shape of a half sphere, and can be made of metal, polymer, or other materials. This system particularly fits the clinical applications of brain image scanning.

The holes can be evenly or unevenly distributed on the frame, depending on the shape of the frame and/or the object to be measured. The rod can be made of metal or polymer, and the diameter of the rod should fit the size of the hole, into which the rod can be inserted.

The rod comprises a sensor 132, which can be an electrode in an EIT system for measuring impedance of the object or a measurement coil in a MIT system for measuring magnetic induction signals. Alternatively, the sensor 132 can be a receiver coil in a MIT system for generating excitation signals. The rod 130 can be inserted into the hole and move along the direction of the hole. The cooperation between the holes and the rods will be explained in the following by explaining the way to measure the position of the sensor 132, i.e. the corresponding position of the surface of the object of interest 101 the sensor 132 is in contact with.

The system 100 further comprises means 140 for measuring the position of each of the sensors 132 when the rod 130 is inserted in the hole and the sensor 132 is in contact with the surface of the object of interest 101.

If the position of the hole is denoted by \vec{P}ᵢ, the direction of the hole is denoted by a unitary vector \vec{n}, and the position of the end of the rod is denoted \vec{E}ᵢ (i.e., the position of the sensor 132), then, if the length of PᵢEᵢ denoted by lᵢ is measured, the position \vec{E}ᵢ of the sensor 132 is determined by the flowing equation:

\vec{E}_{i=\vec{P}}ᵢ+\vec{n}ᵢ·lᵢ [1]

wherein the position of the hole \vec{P}ᵢ and the direction of the hole \vec{n} are known.

There are several ways to measure the length lᵢ.

In an embodiment, to measure lᵢ, the means 140 may comprise a magnetic reader, which is fixed at the entry of the hole and arranged to cooperate with a magnetic railing ruler attached to the rods.

Alternatively, the magnetic railing ruler may be marked on the surface of the rod. The magnetic reader can read the magnetic signal from the magnetic railing ruler when the rod is inserted in the hole and the sensor is attached to the surface of the object of interest, and then the length lᵢ can be calculated with high precision based on the magnetic signal.

By repeating the same procedure, a plurality of positions \vec{E}ᵢ of sensors i=1, 2, . . . , N, N, i being the number of sensors, can be determined. Because the length lᵢ can be measured at real time, the change of sensor positions can be measured immediately.

In an embodiment, the system further comprises a processor 150 for deriving the shape of the object of interest 101, based on the positions of the plurality of sensors. The processor 150 may advantageously execute instruction codes stored in a memory (not shown) to perform this processing. As the sensors are attached to the surface of the object of interest, using the positions of the electrodes and an interpolation of their coordinates, the shape of the object of interest can be derived. The precision of the shape of the object of interest depends on the number of positions of the electrodes and the arrangement of the electrodes.

It is advantageous that the rod 130 comprises a through notch that allows the sensor 132 at one end of the rod 130 to be connected with the processor 150 by a wire through the through notch of the rod. Alternatively, the rod 130 can be hollow to allow a wire extending through the rod 130 to interconnect the sensor 132 and the processor 150. In this way, the processor can collect measurement data sensed by the sensors during monitoring and further process the measurement data for imaging.

FIG. 2 is a schematic diagram showing a second exemplary embodiment of a frame 220 according to the invention.

The frame 220 is shaped as a rectangle having a plurality of holes 221 arranged in known positions and extending in known directions. The holes can cooperate with rods 230 to measure the position of the sensors attached at one end of each rod.

The frame 220 can be put around a human body, for example, around the human chest 201 for lung function monitoring when the patient is lying on a support 202.

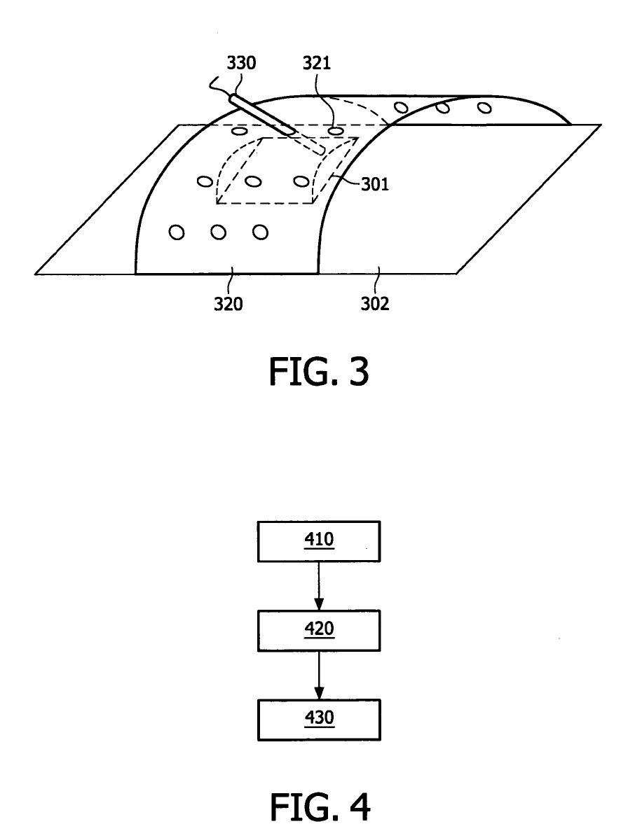

FIG. 3 is a schematic diagram showing a third exemplary embodiment of a frame 320 according to the invention.

The frame 320 is camber-shaped having a plurality of holes 321 arranged in known positions and extending in known directions. The holes can cooperate with rods 330 to measure the position of the sensors attached at one end of each rod.

The frame 330 can be put around the human body, for example, around the human breast 302 for breast monitoring when the patient is lying on a support 302.

The frame 220 is shaped like a rectangle and the frame 320 is shaped like a camber. The frames 220 and 320, respectively, have a plurality of holes 221, 321 arranged in known positions and extending in known directions. The holes can cooperate with rods 230 and 330, respectively, to measure the position of the sensors attached at one end of each rod.

The frame 220 and 330 can be put around a human body, for example, around the human chest 201 for lung function monitoring, or around the human breast 302 for breast monitoring when the patient is lying on a support 202, 302.

It should be noted that the frame of the system can be designed in different shapes to satisfy different clinical applications, i.e., fit the needs for measuring the object of interest 101. For example, in the case of a brain scan, the frame is a half sphere or round in shape, while in the case of a body scan, the frame can be a cylinder, and in the case of a breast scan, the frame can be camber-shaped.

FIG. 4 is a flowchart of the method in accordance with the invention.

According to the process shown in FIG. 4, the method comprises a step 410 of positioning a frame around the object of interest, the frame having a plurality of holes arranged in known positions and extending in known directions, each of the holes being arranged to cooperate with a rod comprising a sensor at one end of the rod.

The method further comprises a step 420 of measuring the position of each of the sensors when the rod is inserted in the hole and the sensor is attached to the surface of the object of interest.

The measuring step 420 may comprise a first sub-step of calculating the distance between the sensor and the entry of the hole by reading a magnetic signal on a magnetic reader, which is fixed at the entry of the hole relative to the known position of the hole and arranged to cooperate with a magnetic railing ruler attached to the rods.

The measuring step 420 may further comprise a second sub-step of calculating the positions of the sensors, based on the distances and the known positions and directions of the holes. The calculation can be performed according to Equation [1].

The method further comprises a step 430 of deriving the shape of the object of interest, based on the positions of the plurality of sensors. As the sensors are attached to the surface of the object of interest, the positions of the plurality of sensors represent a plurality of positions of the surface of the object of interest, and the shape of the object of interest can be derived based on the plurality of positions by using interpolations or other prior art techniques.

It should be noted that the above-mentioned system and method can be used in but are not limited to imaging systems such as EIT or MIT. The skilled person will appreciate that the system and method provided by the invention can be used in other measuring systems, for example, in a welding system where the object to be welded has a special geometry and geometry information is requested for matching the welding rod and torch pipe.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the system claims enumerating several units, several of these units can be embodied by one and the same item of hardware or software. The usage of the words first, second and third, et cetera, does not indicate any ordering. These words are to be interpreted as names.

1. A system (100) for measuring an object of interest (101), said system comprising:
a frame (120, 220, 320) having a plurality of holes (121, 221,321) arranged in known positions and extending in known directions, each hole being arranged to cooperate with a rod (130) comprising a sensor (132); and
means (140) for measuring the position of each sensor (132) when the rod is inserted in the hole (121) and the sensor (132) is in contact with the object of interest (101).

2. A system as claimed in claim 1, wherein the means (140) for measuring comprise a magnetic reader (142) fixed at the entry of the hole (121) and arranged to cooperate with a magnetic railing ruler (135) attached to the rod (130).

3. A system as claimed in claim 2, further comprising a processor (150) for deriving the shape of the object of interest, based on the positions measured by said means (140) for measuring.

4. A system as claimed in claim 1, wherein the frame (120) may be semi-spherical, round, cylindrical, rectangular or camber-shaped.

5. An imaging system comprising a system (100) as claimed in any one of claims 1 to 4.

6. A magnetic induction tomography system comprising a system as claimed in any one of claims 1 to 4.

7. An electrical impedance tomography system comprising a system as claimed in any one of claims 1 to 4.

8. A method of measuring an object of interest (101), said method comprising the steps of:
positioning (410) a frame (120) around the object of interest (101), the frame having a plurality of holes arranged in known positions and extending in known directions, each of the holes (121) being arranged to cooperate with a rod (130) comprising a sensor (132); and
measuring (420) the position of each sensor (132) when the rod (130) is inserted in the hole (121) and the sensor (132) is in contact with the object of interest (101).

9. A method as claimed in claim 8, wherein the measuring step comprises the sub-steps of:
calculating the distance between the sensor (132) and the entry of the hole (121) by reading a signal on a magnetic reader (142), which is fixed at the entry of the hole and arranged to cooperate with a magnetic railing ruler (135) attached to the rod (130); and
calculating the position of the sensor (132), based on the distance and the known positions and directions of the holes.

10. A method as claimed in claim 9, further comprising a step of deriving (430) the shape of the object of interest (101), based on the positions of the plurality of sensors (132).
